(19) United States
(12) Patent Application Publication
(10) Pub. No.: US 2013/0158443 A1
(43) Pub. Date: Jun. 20, 2013

(54) System and Method of Administering Compression Therapy

(71) Applicants: Robert Kraal, Grand Rapids, MI (US); John O. Lindahl, Fruitport, MI (US)

(72) Inventors: Robert Kraal, Grand Rapids, MI (US); John O. Lindahl, Fruitport, MI (US)

(21) Appl. No.: 13/325,180

(22) Filed: Dec. 14, 2011

(51) Int. Cl. A61H 1/00

(52) U.S. Cl. 601/18

(57) ABSTRACT

A method of operating a circulation facilitating assembly having a thermal treatment assembly having the steps of: providing pump assembly; placing a bladder of a first leg assembly in fluid communication with the pump assembly; placing a bladder of a second leg assembly in fluid communication with the pump assembly; placing a bladder of a thermal treatment assembly in fluid communication with the pump assembly, the thermal treatment assembly further comprising a thermal pad which is one of heated or cooled so that it is at a temperature other than ambient temperature; sequentially cycling at least one or both of the first leg assembly and second leg assembly, and, the thermal treatment assembly to complete a single cycle, comprising the steps of by: inflating the respective bladder to a predetermined pressure, holding the predetermined pressure for a predetermined period of time; and deflating the respective bladder.

### BACKGROUND OF THE DISCLOSURE

1. Field of the Disclosure

The disclosure relates in general to medical treatments, and more particularly, to a system and method of administering compression therapy which involves compression therapy to the legs as well as compression therapy (with heat or cold applied thereto) to another part of the body.

2. Background Art

The use of compression therapy is well known in the art. Among other solutions, are the solutions disclosed in U.S. Pat. No. 7,976,486 issued to Raley et al. as well as the other application related thereto, namely, U.S. patent application Ser. No. 13/181,309 filed Jul. 12, 2011, and yet to be published, both of which applications are incorporated in their entirety by reference.

Generally, the device disclosed therein comprises a compact device that can be powered by internal batteries to be truly portable. In addition, the device disclosed therein provides, among other features, sequential inflation and pressurization of a bladder positioned around each calf of a patient. The inflation and pressurization of the bladders aids circulation and precludes DVT.

In addition to providing such therapy, it has been determined that it would be helpful to also apply hot or cold compressive treatment to another portion of the body. For example, at the same time that the patient is utilizing the device, the user may also be receiving hot or cold compressive treatment to another part of the body, such as, for example, the knee, elbow, shoulder, wrist, etc.

Problematically, these therapies are applied by separate equipment, at least some of such equipment cannot be easily transported. Thus, even though the above disclosed prior patents and applications provide for a treatment facilitating circulation in a portable configuration, the compressive treatment to another extremity or body part does not provide for equipment that is transportable. Moreover, even where such equipment is transportable, it would be advantageous if both treatments could be supplied by the same device. Moreover, it would be advantageous if both treatments could be supplied by the same device for extended periods of time in a clinically effective manner.

### SUMMARY OF THE DISCLOSURE

The disclosure is directed to a method of operating a circulation facilitating assembly having a thermal treatment assembly having the steps of: providing pump assembly; placing a bladder of a first leg assembly in fluid communication with the pump assembly; placing a bladder of a second leg assembly in fluid communication with the pump assembly; placing a bladder of a thermal treatment assembly in fluid communication with the pump assembly, the thermal treatment assembly further comprising a thermal pad which is one of heated or cooled so that it is at a temperature other than ambient temperature; sequentially cycling at least one or both of the first leg assembly and second leg assembly, and, the thermal treatment assembly to complete a single cycle, comprising the steps of by: inflating the respective bladder to a predetermined pressure, holding the predetermined pressure for a predetermined period of time; and deflating the respective bladder.

In a preferred embodiment, the step of sequentially cycling each of the first leg assembly, second leg assembly and thermal treatment assembly comprises the sequential steps of: cycling the first leg assembly; cycling the second leg assembly; cycling the first leg assembly a second time; cycling the second leg assembly a second time; and cycling the thermal treatment assembly. Thus, for each complete cycle, the legs are each treated two times, but not more than once in a minute, and the thermal treatment is completed one time.

In one such embodiment, each step of cycling within the step of sequentially cycling comprises about one minute.

In another embodiment, the step of sequentially cycling each of the first leg assembly, second leg assembly and thermal treatment assembly comprises the sequential steps of: cycling the first leg assembly; cycling the first leg assembly; cycling the thermal treatment assembly.

In one embodiment, the step of repeating the step of sequential cycling a predetermined amount of times.

In another embodiment, the method further comprises the steps of: providing a second thermal treatment assembly; replacing the thermal treatment assembly with a second thermal treatment assembly. The second thermal treatment assembly includes a second bladder which is of a different size as compared to the bladder of the thermal treatment assembly. The cycle time is different due to the replacement of the thermal treatment assembly with the second thermal treatment assembly, due to the size difference and the equal pressure to which each is elevated.

In a preferred embodiment, the cycle time comprises about three minutes.

Preferably, the pump assembly further includes a controller and a user input. the user input configured to adjust at least one of cycle time and pressure for each of the bladder of the first leg assembly, the second leg assembly and the thermal treatment assembly. Thus, the user can adjust any one of the foregoing prior to treatment.

In another preferred embodiment, the thermal treatment assembly is structurally configured to retain the thermal pad in operable position to treat at least one of a back region, rib region, hips region, knee region, ankle region, toe region, finger region, wrist region, elbow region, shoulder region and neck region of a patient. Of course, it is not limited to any particular region, and these are not to be considered limiting, rather exemplary.

In another embodiment, the pump assembly further includes a housing. The housing contains a pump, a power source coupled to the pump, a first compressive outlet, a second compressive outlet, a third compressive outlet, a valve, and a controller. The valve selectively places the pump in fluid communication with the first compressive outlet, the second compressive outlet and the third compressive outlet. The controller is coupled to the pump and the valve to control the same.

In a preferred embodiment, the housing of the pump assembly has a length a width and a thickness, none of which exceeds 10 inches.

### BRIEF DESCRIPTION OF THE DRAWINGS

The disclosure will now be described with reference to the drawings wherein:

FIG. 1 of the drawings is a schematic representation of the apparatus of the present invention; and

FIGS. 2a through 2d are graphical depictions of different sample treatments administered to patients and the relative benefits received thereby.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

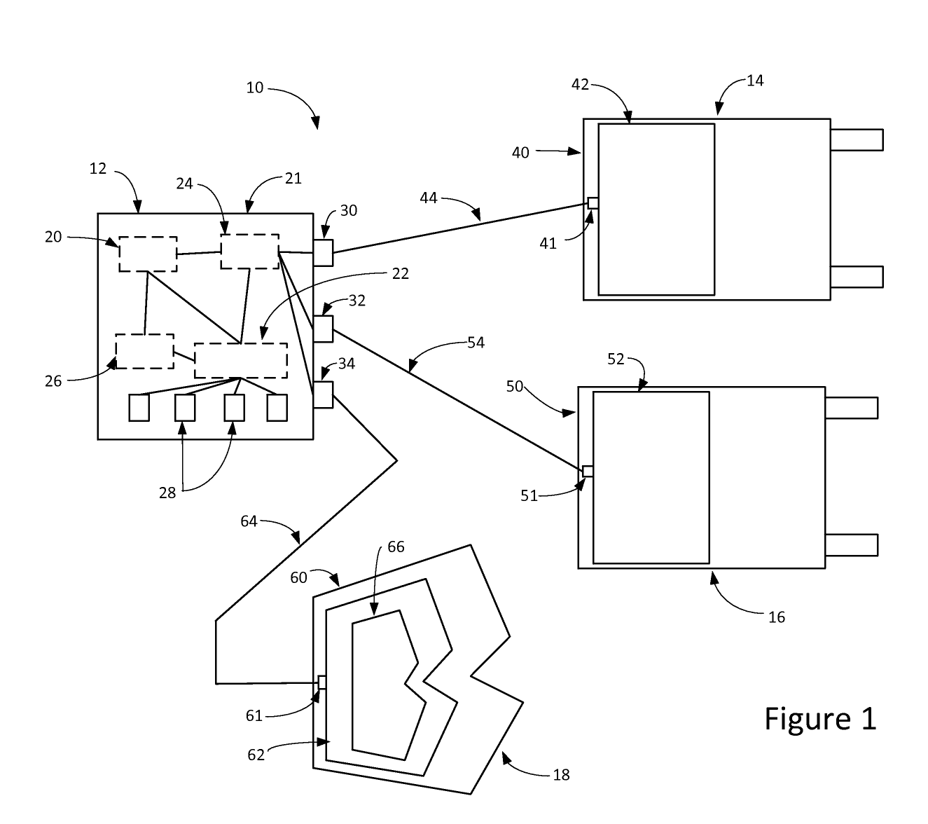

Referring now to the drawings and in particular to FIG. 1, a circulation facilitating and compressive treatment apparatus is shown at 10. The apparatus is similar to the apparatus disclosed in the above-identified incorporated references, namely the patent referenced above and the pending application referenced above. The apparatus includes pump assembly 12, first leg assembly 14, second leg assembly 16 and thermal treatment assembly 18.

As shown schematically in FIG. 1, the apparatus includes pump 20, controller 22, valve 24, power source 26, user input/control 28, first compressive outlet 30, second compressive outlet 32 and third compressive outlet 34. It is contemplated that the apparatus is sized so as to be handheld, portable and self-contained so that the foregoing components are contained within the housing 21 thereof. In one embodiment it is contemplated that the device is approximately 6-8 inches long, 4-6 inches wide and less than 2.5 inches thick. Of course, the apparatus is not limited to any particular size, or any particular portable dimension.

The pump 20 is coupled to the power source 26 and the valve 24 so that the pump can be driven by the power source 26 to direct air (or another gas/fluid) through any one of the outlets 30, 32 and 34, as directed by the valve 24. The pump 20 and the valve 24 are controlled by the controller so that the proper pressure is directed into the proper outlet. A number of sensors, including, but not limited to pressure, time, volumetric, etc are contemplated for use in association with the controller to assist with the monitoring and the controlling of the pump and valve. It will be understood that while a single pump is shown and a single valve is shown, it is likewise contemplated that the device may comprise any number of pumps (i.e., one pump for multiple outlets, or one pump per outlet, or multiple pumps per outlet). Additionally, while a single three position valve is contemplated that can direct the output of the pump to any one of the outlets, in other embodiments, a plurality of valves may be utilized.

The power source is contemplated as being a number of rechargeable battery cells that are arranged either one or both of in parallel and in series. The cells may comprise NIMH, Li-ion, or other types of cells. A further charging circuitry is employed to charge the devices as needed. It will be understood that other means of powering the devices is likewise contemplated as a replacement for or a supplement to the rechargeable cells disclosed, including, solar cells, fuel cells, inductive circuits and the like, as well as wall outlets. It will be understood that it is preferred, but not required, that the power source provide sufficient power in order to fully operate the apparatus through at least one extended treatment period.

The apparatus may be capable of a number of different functions and a number of different treatment variations. As such, a user input is provided to the system. It is contemplated that the device may include a plurality of buttons, on for example, the top surface of the device to control power, treatment pressure, treatment cycles, and the mode (one leg, two leg, without or without thermal compression, etc.). In other embodiments, the user input may comprise a memory card or other device which is electronically linked to the device (i.e., such as an SD card through an SD card slot in the device). In other embodiments, the system is controlled wirelessly from an outside device, such as a smartphone, or computer or tablet or the like. In certain embodiments, the outside device can perform total control, whereas in other embodiments, it may be used for programming purposes solely. In still further embodiments, a wired (USB, etc.) or wireless communication can be utilized to set various parameters, or to export compliance data.

The first leg assembly 14 is shown as comprising housing 40, bladder 42 and hose 44. The housing 40 comprises a wrap that is configured to extend about the calf of the user so as to sandwich the bladder therebetween. Typically, the housing may include a fabric which is both absorbent, breathable and that is comfortable to the user. The housing includes a hook and loop fastener so that after it is wrapped around the calf of the user, the ends can be secured to each other. Of course, other retaining configurations are likewise contemplated, and while the wrap is shown as a substantially planar material, it is contemplated that it may be shaped or the like. It is also contemplated that the housing 40 may include provisions for holding or otherwise facilitating the use of sensors and the like, along with a pocket or other retaining means by which to retain the bladder.

The bladder 42 is shown in FIG. 1 as comprising a pillow type bladder having two opposing surfaces that are joined together about a perimeter so as to provide a substantially fluid-tight cavity. An opening 41 is provided to the bladder, through which the hose 44 is attached. It will be understood that while a single bladder compartment or cavity is shown, multiple compartments, each fed by a single or by multiple hoses, as well as valves between the bladders is contemplated for use. In many embodiments, the bladder and the housing are a single integrated unit wherein the features and the functionality of the joined bladder and housing is in a single structure.

The hose 44 is shown as extending from first compressive outlet 30 to the opening 41 so as to place the two in fluid communication. It will also be understood that, as set forth above, a plurality of hoses (each of which would be coupled to separate compressive outlets) could be utilized (i.e., with each leg having a number of bladders that inflate in a coordinated manner).

The second leg assembly 16 is shown as comprising housing 50, bladder 52 and hose 54. The second leg assembly is substantially identical to the first leg assembly 14, although variations are contemplated. The housing 50 comprises a wrap that is configured to extend about the calf of the user so as to sandwich the bladder therebetween. Typically, the housing may include a fabric which is both absorbent, breathable and that is comfortable to the user. The housing includes a hook and loop fastener so that after it is wrapped around the calf of the user, the ends can be secured to each other. Of course, other retaining configurations are likewise contemplated, and while the wrap is shown as a substantially planar material, it is contemplated that it may be shaped or the like. It is also contemplated that the housing 50 may include provisions for holding or otherwise facilitating the use of sensors and the like, along with a pocket or other retaining means by which to retain the bladder.

The bladder 52 is shown in FIG. 1 as comprising a pillow type bladder having two opposing surfaces that are joined together about a perimeter so as to provide a substantially fluid-tight cavity. An opening 51 is provided to the bladder, through which the hose 44 is attached. It will be understood that while a single bladder compartment or cavity is shown, multiple compartments, each fed by a single or by multiple hoses, as well as valves between the bladders is contemplated for use. In many embodiments, the bladder and the housing are a single integrated unit wherein the features and the functionality of the joined bladder and housing is in a single structure.

The hose 54 is shown as extending from second compressive outlet 32 to the opening 51 so as to place the two in fluid communication. It will also be understood that, as set forth above, a plurality of hoses (each of which would be coupled to separate compressive outlets) could be utilized (i.e., with each leg having a number of bladders that inflate in a coordinated manner).

The thermal treatment assembly 18 is shown in FIG. 1 as comprising housing 60, bladder 62, hose 64 and thermal element 66. The thermal treatment assembly 18 may have a plurality of differently shaped housings 60 so as to facilitate the coupling thereof to a number of different outside body areas. As with the housings of the leg assemblies, the housing may comprise a wrap which extends about an area to be treated, and may include some attachment member (such as a hook and loop fastener) to join and retain the ends of the wrap in the proper orientation. The bladder further includes For example, the housing 60 may comprise a shape that is configured to extend about a shoulder of a user/patient. In other embodiments, the housing may comprise a shape that is configured to extend about a knee of a user. Other areas which may receive thermal treatment include, any number of different areas, including but not limited to, back, ribs, hips, knees, ankle, toes, fingers, wrists, elbows, shoulders and neck. The disclosure is not limited to the treatment of any particular region of the body.

The bladder 62 is shown in FIG. 1 as comprising a pillow type bladder having two opposing surfaces that are joined together about a perimeter so as to provide a substantially fluid-tight cavity. An opening 61 is provided to the bladder, through which the hose 64 is attached. As with the leg assemblies, a single bladder is shown, but it is contemplated that multiple bladders may be utilized. In many embodiments, the bladder and the housing are a single integrated unit wherein the features and the functionality of the joined bladder and housing is in a single structure.

The hose 64 is shown as extending from third compressive outlet 34 to the opening 61 so as to place the two in fluid communication. It will also be understood that, as set forth above, a plurality of hoses (each of which would be coupled to separate compressive outlets) could be utilized (i.e., with each leg having a number of bladders that inflate in a coordinated manner).

The thermal pad 66 is shown in FIG. 1 as comprising a substantially planar bag like element (or pad) having a fluid positioned therein. The fluid positioned within the bag is typically configured for heating and/or cooling, and has effective properties with respect to thermal treatment. It will be understood that, in operation, a user thermally treats the thermal pad 66 in a warm or a cold environment so as to either heat or cool the pad. Once it has been thermally treated, it can be coupled to the housing 60 so as to be retained between the housing and the area of a user/patient to be treated. Typically, the bladder is positioned between the housing 60 and the thermal pad 66, where the bladder and the housing are separate elements.

Significantly, there are typically issues associated with the proper administration of the pressure to the leg assemblies and the thermal treatment assemblies. In particular, one difficulty is that the thermal treatment assembly can vary in size quite a bit depending on the region or area to be treated. As such, it is difficult to coordinate the pressurization of each of the leg assemblies and also the thermal treatment assembly so that effective treatment is administered to each one of them.

It has been found that treatment based upon both pressure and time can provide the requisite coordination between the pressurization of each one of the devices. To effectively treat the patient, a treatment protocol only partially based upon a set time period is utilized. In the case of the present embodiment, the treatment time period is approximately three minutes but can vary depending on the affected areas and the chosen treatments and physical characteristics of the treatment and the patient. Within the treatment period, treatment is administered to each of the legs, if selected, and to the thermal treatment assembly, if selected.

To achieve the treatment, in the case of treatment to both leg assemblies and the thermal treatment assembly, the bladder of the first leg assembly is first filled to a desired pressure (in one embodiment, i.e., 50 mmHg.). It is known that regardless of the size of the leg of the user, such a treatment takes roughly thirty seconds in which to fill the bladder of the leg assembly and to hold the pressure for the desired time, and to deflate the bladder. It will be understood that there will be some variability based upon patient leg size, bladder size, bladder position, temperature, etc.

As such, to complete the cycle, the controller 22 directs the pump to pump air through the valve 24 to be directed to the bladder 42 of the first leg assembly until a desired pressure is reached (i.e., 50 mmHg). This is typically achieved in and around approximately eight seconds, although not limited thereto. Once the desired pressure is reached, it is held for a predetermined period of time, in this case five seconds. At the end of that time period, the air is released from the bladder and the bladder deflates. The deflation continues for approximately fifteen seconds at which time the pressure is approximately zero. For most uses, the inflation, hold and deflation is completed in approximately less than thirty seconds.

At the conclusion of this treatment (which is largely pressure based), the same cycle is repeated with respect to the second leg. In particular, the controller 22 directs the pump to pump air through the valve 24, and directs valve 24 to direct air to the bladder 52 of the second leg assembly. This continues until the desired pressure is reached (i.e., 50 mmHg). The pressure is then held in the second bladder 52 for a predetermined period of time, again, in the embodiment described, five seconds. At the conclusion of the hold period, the bladder is deflated for approximately fifteen seconds. Thus the treatment is about thirty seconds, but only approximately.

These two steps are repeated again. At the conclusion, somewhere near two minutes has elapsed, and each leg was treated twice. Next, the thermal treatment assembly 18 is then actuated to provide compression thermal treatment to the affected area of the user. As such, the controller 22 directs the pump 20 to pump air to the valve 24, and directs the valve 24 to fill the bladder 62 through the third compressive outlet 34 until a desired pressure is reached. In the embodiment shown, a pressure of 45 mmHg is contemplated. As the different bladders for the different parts of the body can be of vastly different sizes, there can be a relatively large variation in the fill times (i.e., eight to forty-five seconds, for example). Nevertheless, once it is filled, the pressure is held for a predetermined period of time. Once the pressure is held for the predetermined period of time (i.e., ten seconds), the cuff is deflated for a period of 10 seconds. It has been found that the period of 10 seconds, while not evacuating all of the air within the bladder, reduces the pressure to approximately zero (or a very low pressure). The system then pauses for a period of time (without venting) so that time is elapsed without further losing the volume of air within the bladder. The amount of time varies with treatment, i.e. five seconds to thirty seconds or so.

Once this cycle is complete, the cycle will start again. Through the combination of the time and pressure cycle, the user is guaranteed that over an approximate three minute span, each leg has been treated twice, and the thermal treatment assembly has been inflated once. Thus, compliance is easily achieved. Moreover, it is not required that the pump assembly know the type of thermal treatment assembly that will be utilized. Nor is it necessary to know various properties of the user and the area to be thermally treated. The system automatically adjusts to differences in the different users and other variables, as well as in the different areas to be treated as the system relies upon pressure and time.

It will be understood that the above timing and pressure settings for each of the bladders can be varied within the scope of the present disclosure (i.e. the 45 mmHg and 50 mmHg are merely illustrative). For example, a total treatment time of more or less than three minutes can be utilized. Further, a treatment time for each leg assembly and the thermal treatment assembly can be varied relative to each other, as can be the time required to hold pressure. Rather, the significance of one aspect of the disclosure is that different users having different physical features and different thermal treatment areas can utilize a single pump assembly that does not require reprogramming of coordination between the pump assembly, the leg assemblies and the thermal treatment assemblies.

A number of different treatment possibilities are contemplated. For illustrative purposes only, sample hold times for each leg are contemplated to be five seconds, and hold times for thermal treatment is contemplated to be 20 seconds. It is also contemplated that the pressure settings can be patient or doctor/therapist set at between, for example, 20 and 99 mmHg and between 15 and 45 mmHg. It will be understood that this range can be different for the patient and the doctor/therapist so that the window of adjustment for the patient is smaller than that of the doctor. It will also be understood that after receiving a low pressure warning (i.e., lack of pressure that exceeds the lower limit) for a predetermined period of time, the apparatus will determine a malfunction of some component as there is no substantive inflation.

It will be understood that further changes can likewise be made to the system, wherein certain data pertaining to the leg assemblies and the thermal treatment assembly is passed to the pump assembly, and such information is utilized to control the treatment. However, it will be understood that the time and pressure manner in which to control the treatment process ban be utilized with or without having the additional information pertaining to the system.

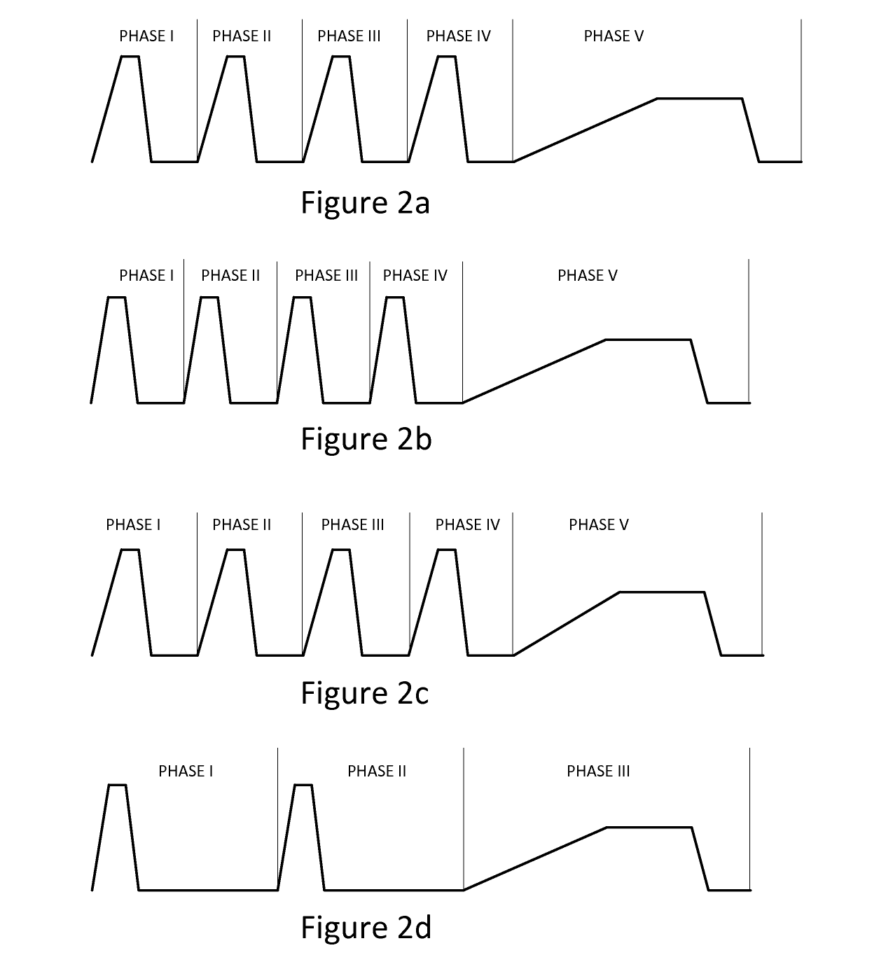

FIGS. 2a through 2d disclose a number of different treatments that can be administered, wherein each treatment is shown in a slightly different line shading. The first set of treatment types, administered under different circumstances in each of the figures is shown sequentially in FIGS. 2a through 2c. In each example, treatment was administered in the following order: Phase I, first leg; Phase II, second leg; Phase III, first leg; Phase IV, second leg; Phase V, thermal treatment. It will be understood that other treatment modes are contemplated, and the different modes include, a single leg (either leg), dual leg, thermal assembly with single leg, thermal assembly with dual leg, and thermal assembly alone.

In the FIG. 2a, the patient and leg assembly takes relatively more time to fill in each leg than in FIG. 2b, which is shown by the slope of the rising line being greater in FIG. 2b than it is in FIG. 2a. Nevertheless, over the time t, both of the leg assemblies inflated to the same pressure, and held that pressure for the same amount of time. The same is true for the second inflation of the first leg (Phase III) and both of the inflations of the second leg (Phases II and IV). The difference is in the overall treatment time, which is longer in the treatment shown in FIG. 2a

In the example of FIGS. 2a and 2b, the same area of the patient was treated, but due to variations in the patients there was a slight variation in the time to fill the bladder to the desired pressure. Nevertheless, over a treatment, each bladder shown in FIGS. 2a and 2b were elevated to the same pressure and held at that pressure for the same period of time, while the overall cycle times are varied.

Moving to FIG. 2c, a different area of the patient of FIG. 2b was treated, and, as such, while the Phases I through IV are identical between FIGS. 2b and 2c, Phase V is different in that with the example of FIG. 2c, the bladder took shorter to inflate to pressure (a result from treating an area that required a smaller bladder). Nevertheless, in each of the Phases V for the treatments reflected in FIGS. 2b and 2c, the thermal treatment assembly applied the same desired pressure for the same amount of time. The difference is in the overall treatment time.

While the individual treatments were different between those shown in FIGS. 2a through 2c, each area treated was elevated to the same pressure and held at that pressure for the same amount of time. The difference is in the overall different treatment times.

FIG. 2(d) is a graphical description of a treatment of patient wherein only one leg was treated and wherein the thermal treatment assembly was likewise utilized. In such a treatment, phases II and IV are eliminated, and phases I and III are extended to encompass a greater amount of time.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A method of operating a circulation facilitating assembly having a thermal treatment assembly comprising the steps of:
providing pump assembly;
placing a bladder of a first leg assembly in fluid communication with the pump assembly;
placing a bladder of a second leg assembly in fluid communication with the pump assembly;
placing a bladder of a thermal treatment assembly in fluid communication with the pump assembly, the thermal treatment assembly further comprising a thermal pad which is one of heated or cooled so that it is at a temperature other than ambient temperature;
sequentially cycling at least one or both of the first leg assembly and second leg assembly, and, the thermal treatment assembly to complete a single cycle, comprising the steps of by:
inflating the respective bladder to a predetermined pressure,
holding the predetermined pressure for a predetermined period of time; and
deflating the respective bladder.

2. The method of claim 1 wherein the step of sequentially cycling each of the first leg assembly, second leg assembly and thermal treatment assembly comprises the sequential steps of:
cycling the first leg assembly;
cycling the second leg assembly;
cycling the first leg assembly a second time;
cycling the second leg assembly a second time; and
cycling the thermal treatment assembly.

3. The method of claim 2 wherein each step of cycling within the step of sequentially cycling comprises about one minute.

4. The method of claim 1 wherein the step of sequentially cycling each of the first leg assembly, second leg assembly and thermal treatment assembly comprises the sequential steps of:
cycling the first leg assembly;
cycling the first leg assembly;
cycling the thermal treatment assembly.

5. The method of claim 1 further comprising the step of repeating the step of sequential cycling a predetermined amount of times.

6. The method of claim 1 wherein the method further comprises the steps of:
providing a second thermal treatment assembly;
replacing the thermal treatment assembly with a second thermal treatment assembly wherein the second thermal treatment assembly includes a second bladder which is of a different size as compared to the bladder of the thermal treatment assembly,
wherein the cycle time is different due to the replacement of the thermal treatment assembly with the second thermal treatment assembly.

7. The method of claim 1 wherein the cycle time comprises about three minutes.

8. The method of claim 1 wherein the pump assembly further includes a controller and a user input, the user input configured to adjust at least one of cycle time and pressure for each of the bladder of the first leg assembly, the second leg assembly and the thermal treatment assembly.

9. The method of claim 1 wherein the thermal treatment assembly is structurally configured to retain the thermal pad in operable position to treat at least one of a back region, rib region, hips region, knee region, ankle region, toe region, finger region, wrist region, elbow region, shoulder region and neck region of a patient.

10. The method of claim 1 wherein the pump assembly further includes a housing which includes a pump, a power source coupled to the pump, a first compressive outlet, a second compressive outlet, a third compressive outlet, a valve, the valve selectively placing the pump in fluid communication with the first compressive outlet, the second compressive outlet and the third compressive outlet, and a controller coupled to the pump and the valve to control the same.

11. The method of claim 10 wherein the housing of the pump assembly has a length a width and a thickness, none of which exceeds 10 inches.
